(19) United States
(12) Patent Application Publication
(10) Pub. No.: US 2017/0171638 A1
(43) Pub. Date: Jun. 15, 2017

(54) Method and Terminal for Video Play

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Xiaoyue LIU, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/242,239

(22) Filed: Aug. 19, 2016

Related U.S. Application Data
(63) Continuation of application No. PCT/CN2016/088675, filed on Jul. 5, 2016.

(30) Foreign Application Priority Data
Dec. 15, 2015 (CN) 201510937841.X

(51) Int. Cl. H04N 21/6587; H04N 21/858; H04N 21/4788; H04N 21/472

(52) U.S. Cl. CPC H04N 21/6587; H04N 21/47217; H04N 21/8586; H04N 21/4788

(57) ABSTRACT

The present disclosure discloses a method and terminal for video play, wherein the method at a terminal device side includes: receiving playback node information sent by a server during a play of a live broadcast video, wherein the playback node information includes a playback time point of the video; displaying the playback node information on a live broadcast page of the video; generating a playback instruction according to the playback time point contained in the playback node information when a user clicks the playback node information; and sending the playback instruction to the server to make the server provide the video starting from the playback time point. In embodiments of the present disclosure, after a terminal device receives playback node information and displays the same to a user, the user may click a certain playback node information therein so as to send a playback instruction to the server, which makes the server provide a video starting from the playback node, thereby the playback of the live broadcast video may be realized during live broadcast, and the playback timeliness of the live broadcast video may be improved.

### CROSS REFERENCE TO RELATED APPLICATION

The present disclosure is a continuation of international application No. PCT/CN2016/088675 filed on Jul. 5, 2016, and claims a priority of Chinese Patent Application No. 201510937841.X filed on Dec. 15, 2015, titled “METHODS AND DEVICES FOR VIDEO PLAY”, both of which are incorporated herein by reference in their entireties.

### TECHNICAL FIELD

The present disclosure relates to the field of communication technologies, and in particular, to a method and terminal for video play.

### BACKGROUND

At present, watching a video programme via a terminal device such as a TV set, a mobile phone and a tablet computer has become indispensable in people's daily life. Generally, video programmes may be divided into live broadcast programme and on-demand programme. An on-demand programme may have a playback function, that is, during watching, by dragging or clicking a progress bar, a user may return to a certain time point before the current time to playback a marvelous content of the programme.

For a live broadcast programme, no playback function is provided to a user during live broadcast, and playback can be realized after an on-demand programme is formed subsequent to the live broadcast, which has a strong posteriority.

### SUMMARY

In order to overcome the problems, embodiments of the present disclosure provide a method and terminal for video play, so as to solve the technical problem that a live broadcast video cannot be played back.

In a first aspect of embodiments of the present disclosure, there provides a method for video play, which is applied to a terminal device, and the method includes:
receiving playback node information sent by a server during a play of a live broadcast video, wherein the playback node information includes a playback time point of the video;
displaying the playback node information on a live broadcast page of the video;
generating a playback instruction according to the playback time point contained in the playback node information when a user clicks the playback node information; and
sending the playback instruction to the server to make the server provide the video starting from the playback time point.

In a second aspect of embodiments of the present disclosure, there provides a method for video play, which is applied to a server, the method includes:
generating playback node information for a current live broadcast video, wherein the playback node information includes a playback time point of the video;
pushing the playback node information to each of terminal devices that are playing the video;
receiving a playback instruction sent by a first terminal device, wherein the playback instruction includes a first time point, which is a playback time point of the video by the first terminal device; and
providing the video starting from the first time point to the first terminal device according to the playback instruction.

According to a third aspect of embodiments of the present disclosure, there provides a terminal including at least one processor and a memory, wherein the memory is stored with instructions executable by the one or more processors, and the instructions are set to perform any one of the methods according to the first aspect of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

To illustrate technical schemes in embodiments of the present disclosure or the prior art more clearly, figures used in the description of embodiments or the prior art are described briefly as follows. It is obvious that the figures in the description below are some embodiments of the present disclosure, and one of ordinary skilled in the art can obtain other figures according to those following figures without any creative work.

FIG. 1 is a flow chart of a method for video play according to an exemplary embodiment;

FIG. 2 is a schematic diagram showing an interface of playback node information according to an exemplary embodiment;

FIG. 3 is a schematic diagram showing an image-text description of playback node information according to an exemplary embodiment;

FIG. 4 is a schematic diagram showing a playback interface according to an exemplary embodiment;

FIG. 5 is a schematic diagram showing sharing of playback node information according to an exemplary embodiment;

FIG. 6 is a flow chart of a method for video play according to an exemplary embodiment;

FIG. 7 is a flow chart of a method for video play according to an exemplary embodiment;

FIG. 8 is a block diagram of a device for video play according to an exemplary embodiment;

FIG. 9 is a block diagram of a device for video play according to an exemplary embodiment;

FIG. 10 is a block diagram of a device for video play according to an exemplary embodiment;

FIG. 11 is a block diagram of a device for video play according to an exemplary embodiment;

FIG. 12 is a block diagram of a terminal for video play according to an exemplary embodiment; and

FIG. 13 is a block diagram of a server for video play according to an exemplary embodiment.

### DETAILED DESCRIPTION

Exemplary embodiments, of which examples are shown in the drawings, will be illustrated in detail herein. When the description below is related to the drawings, same reference numeral in different drawings represents same or similar element, unless otherwise expressed. The implementations described in the following exemplary embodiments do not represent all the implementations consistent with the present disclosure. Instead, they are only examples of device and method consistent with some aspects of the present disclosure as described in detail in the appended claims.

FIG. 1 is a flow chart of a method for video play according to an exemplary embodiment. The method may be applied to a terminal device, for example, a mobile phone, a tablet computer and a TV set, etc.

Referring to FIG. 1, the method may include the following steps.

In step S101, playback node information sent by a server is received during the play of a live broadcast video, wherein the playback node information includes a playback time point of the video.

For example, during the live broadcast of a programme, a working personnel may record the time of a marvelous node of the programme, compile and generate playback node information, and upload the playback node information to the server, so that the server sends the playback node information to multiple terminal devices that are playing the live broadcast video. The server may also determine which time points correspond to marvelous nodes according to some preset rules, and generate playback node information automatically.

In step S102, the playback node information is displayed on a live broadcast page of the video.

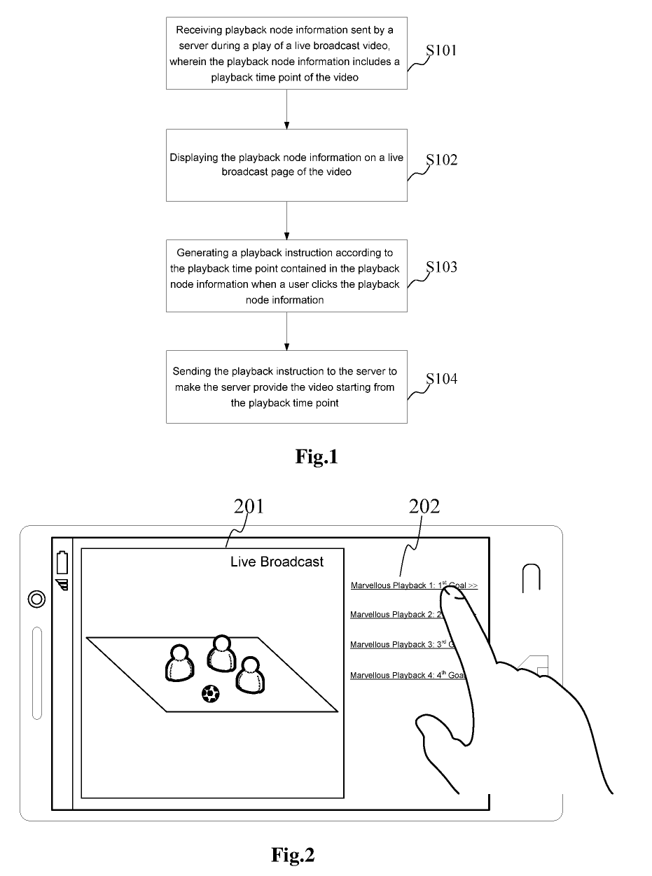

As an example, referring to FIG. 2, 201 is a video live broadcast window on a mobile phone, and multiple playback node information received by the mobile phone is displayed on the right of the window 201, wherein 202 is a playback node information.

In step S103, a playback instruction is generated according to the playback time point contained in the playback node information when a user clicks the playback node information.

As an example, the generated playback instruction may be a Uniform Resource Locator (URL), and a parameter in the URL includes the playback time point.

In step S104, the playback instruction is sent to the server to make the server provide the video starting from the playback time point.

For example, when the user clicks one playback node information therein, the mobile phone opens the corresponding URL, which is equivalent to that the mobile phone sends a playback instruction to the server. The server may provide a live broadcast video stream starting from the playback time point to the mobile phone in a page corresponding to the URL.

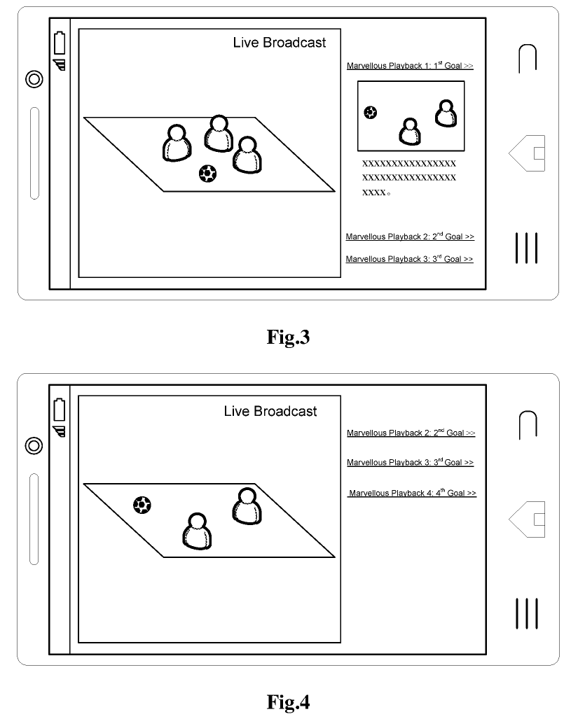

As an example, referring to FIG. 3, after the user clicks a certain playback node information in FIG. 2, it may jump to the playback page shown in FIG. 3.

In this embodiment or some other embodiments of the present disclosure, the playback node information may further include a picture and\or literal description corresponding to the playback time point.

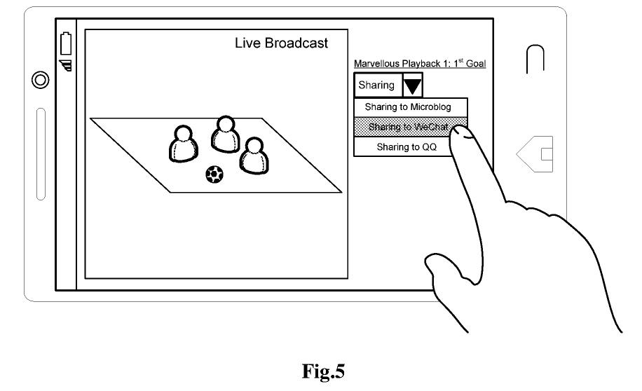

As an example, referring to FIG. 4, after the user clicks a playback node information “marvelous point”, the user may see image-text information that is unfolded and obtain an introduction of the marvelous point.

Additionally, in this embodiment or some other embodiments of the present disclosure, the method may further include: sharing the URL according to an operation of the user.

As an example, referring to FIG. 5, after the user clicks a certain playback node information, the user may select to share the generated URL, for example, the user may send the URL to a Friend Circle or Chat Group, thus other users may see the marvelous programme at the corresponding time point by opening the URL.

In this embodiment, a server may generate playback node information for a live broadcast video (for example, it may be automatically generated according to a rule, or it may be generated by a working personnel via an operation) and then push it to each of terminal devices; after a terminal device receives the playback node information and displays it to a user, the user may click a certain playback node information therein so as to send a playback instruction to the server, which makes the server provide a video starting from the playback node, thereby the playback of the live broadcast video may be realized during live broadcast, and the playback timeliness of the live broadcast video may be improved.

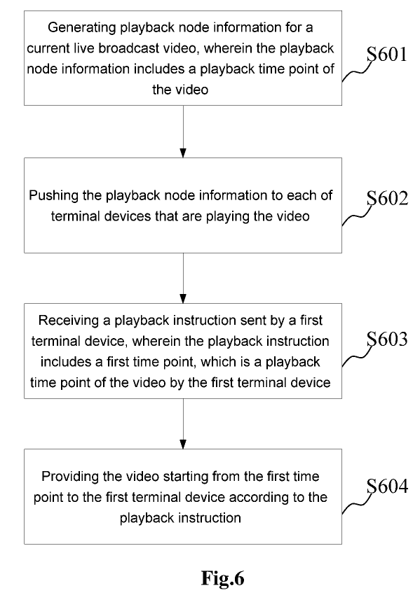

FIG. 6 is a flow chart of a method for video play according to an exemplary embodiment. The method may be applied to a server.

Referring to FIG. 6, the method may include the following steps.

In step S601, playback node information for a current live broadcast video is generated, wherein the playback node information includes a playback time point of the video.

For example, during the live broadcast of a programme, a working personnel may record the time of a marvelous node of the programme, compile and generate playback node information, and upload the playback node information to the server, so that the server sends the playback node information to multiple terminal devices that are playing the live broadcast video. The server may also determine which time points correspond to marvelous nodes according to some preset rules, and generate playback node information automatically. For the manner in which the server generates the playback node information, it will not be limited in this embodiment, and all the manners that may be used herein will not depart from the spirit and protection scope of the present disclosure.

Additionally, in this embodiment or some other embodiments of the present disclosure, the playback node information may further include a picture and\or literal description corresponding to the playback time point.

In step S602, the playback node information is pushed to each of terminal devices that are playing the video.

After each of the terminal devices receives the playback node information, the terminal devices may display the playback node information to the user for being selected by the user.

In step S603, a playback instruction sent by a first terminal device is received, wherein the playback instruction includes a first time point, which is a playback time point of the video by the first terminal device.

The user may click the playback node information so as to generate a playback instruction and send it to the server.

As an example, the playback instruction may be a Uniform Resource Locator (URL), and a parameter in the URL includes the first time point.

It should be pointed out that, the first terminal device may or may not be one of the above “each of the terminal devices”, because in some cases, the received playback node information may be shared among the terminal devices, therefore, even if the first terminal device does not receive the playback node information pushed by the server, it may receive the playback node information from other terminals.

In Step S604, the video starting from the first time point is provided to the first terminal device according to the playback instruction.

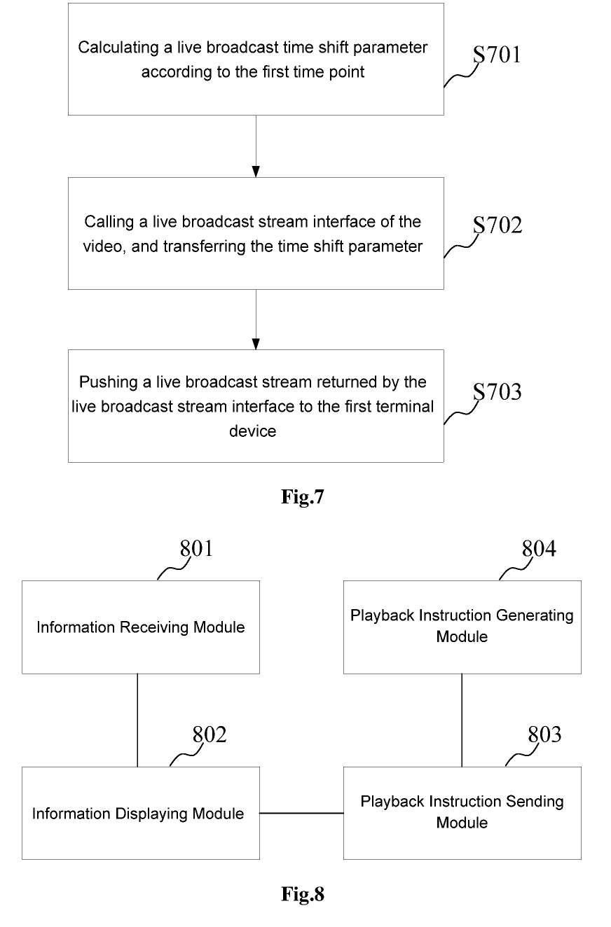

As an example, referring to FIG. 7, the providing the video starting from the first time point to the first terminal device according to the playback instruction may include the following steps.

In step S701, a live broadcast time shift parameter is calculated according to the first time point.

In step S702, a live broadcast stream interface of the video is called, and the time shift parameter transferred.

In step S703, a live broadcast stream returned by the live broadcast stream interface is pushed to the first terminal device.

In this embodiment, a server may generate playback node information for a live broadcast video (for example, it may be automatically generated according to a rule, or it may be generated by a working personnel via an operation) and then push it to each of terminal devices; after a terminal device receives the playback node information and displays it to a user, the user may click a certain playback node information therein so as to send a playback instruction to the server, which makes the server provide the video starting from the playback node, thereby the playback of the live broadcast video may be realized during live broadcast, and the playback timeliness of the live broadcast video may be improved.

Embodiments of device according to the present disclosure will be described below, which may be configured to execute the method according to embodiments of the present disclosure. For the details that are not disclosed in the embodiments of device according to the present disclosure, reference may be made to the embodiments of method according to the present disclosure.

FIG. 8 is a block diagram of a device for video play according to an exemplary embodiment. The device may be applied to a terminal device, for example, a mobile phone, a tablet computer and a TV set, etc.

Referring to FIG. 8, the device may include the following modules.

An information receiving module 801 receives playback node information sent by a server during a play of a live broadcast video, wherein the playback node information includes a playback time point of the video;

For example, during the live broadcast of a programme, a working personnel may record the time of a marvelous node of the programme, compile and generate playback node information, and upload the playback node information to the server, so that the server sends the playback node information to multiple terminal devices that are playing the live broadcast video. The server may also determine which time points correspond to marvelous nodes according to some preset rules, and generate playback node information automatically.

An information displaying module 802 displays the playback node information on a live broadcast page of the video;

As an example, referring to FIG. 2, 201 is a video live broadcast window on a mobile phone, and multiple playback node informations received by the mobile phone are displayed on the right of the window 201, wherein 202 is a playback node information.

A playback instruction generating module 803 generates a playback instruction according to the playback time point contained in the playback node information when a user clicks the playback node information;

As an example, the generated playback instruction may be a Uniform Resource Locator (URL), and a parameter in the URL includes the playback time point.

A playback instruction sending module 804 sends the playback instruction to the server to make the server provide the video starting from the playback time point.

For example, when the user clicks one playback node information therein, the mobile phone opens the corresponding URL, which is equivalent to that the mobile phone sends a playback instruction to the server. The server may provide a live broadcast video stream starting from the playback time point to the mobile phone in a page corresponding to the URL.

As an example, referring to FIG. 3, after the user clicks a certain playback node information in FIG. 2, it may jump to the playback page shown in FIG. 3.

In this embodiment or some other embodiments of the present disclosure, the playback node information may further include a picture and\or literal description corresponding to the playback time point.

As an example, referring to FIG. 4, after the user clicks a playback node information “marvelous point”, the user may see image-text information that is unfolded and obtain an introduction of the marvelous point.

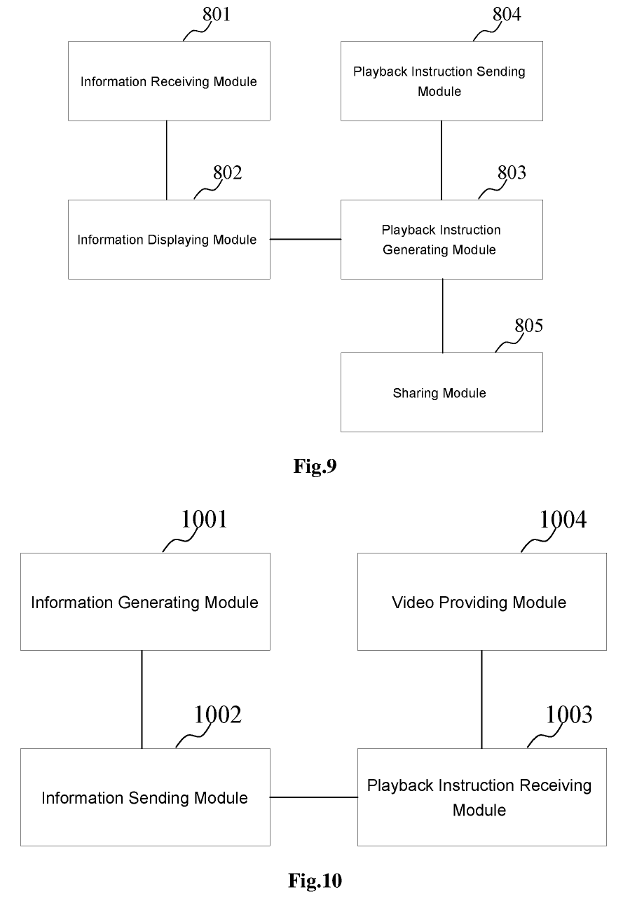

Referring to FIG. 9, in this embodiment or some other embodiments of the present disclosure, the device may further include a sharing module 805, which shares the URL according to an operation of the user.

As an example, referring to FIG. 5, after the user clicks a certain playback node information, the user may select to share the generated URL, for example, the user may send the URL to a Friend Circle or Chat Group, thus other users may see the marvelous programme at the corresponding time point by opening the URL.

In this embodiment, a server may generate playback node information for a live broadcast video (for example, it may be automatically generated according to a rule, or it may be generated by a working personnel via an operation) and then push it to each of terminal devices; after a terminal device receives the playback node information and displays it to a user, the user may click a certain playback node information therein so as to send a playback instruction to the server, which makes the server provide a video starting from the playback node, thereby the playback of the live broadcast video may be realized during live broadcast, and the playback timeliness of the live broadcast video may be improved.

FIG. 10 is a block diagram of a device for video play according to an exemplary embodiment. The device may be applied to a server.

Referring to FIG. 10, the device may include the followings modules.

An information generating module 1001 generates playback node information for a current live broadcast video, wherein the playback node information includes a playback time point of the video.

For example, during the live broadcast of a programme, a working personnel may record the time of a marvelous node of the programme, compile and generate playback node information, and upload the playback node information to the server, so that the server sends the playback node information to multiple terminal devices that are playing the live broadcast video. The server may also determine which time points correspond to marvelous nodes according to some preset rules, and generate playback node information automatically. For the manners in which the server generates the playback node information, it will not be limited in this embodiment, and all the manners that may be used herein will not depart from the spirit and protection scope of the present disclosure.

Additionally, in this embodiment or some other embodiments of the present disclosure, the playback node information may further include a picture and\or literal description corresponding to the playback time point.

An information sending module 1002 pushes the playback node information to each of terminal devices that are playing the video.

After each of the terminal devices receives the playback node information, the terminal devices may display the playback node information to the user for being selected by the user.

A playback instruction receiving module 1003 receives a playback instruction sent by a first terminal device, wherein the playback instruction includes a first time point, which is a playback time point of the video by the first terminal device.

The user may click the playback node information so as to generate a playback instruction and send it to the server.

As an example, the playback instruction may be a Uniform Resource Locator (URL), and a parameter in the URL includes the first time point.

It should be pointed out that, the first terminal device may or may not be one of the above “each of the terminal devices”, because in some cases, the received playback node information may be shared among the terminal devices, therefore, even if the first terminal device does not receive the playback node information pushed by the server, it may receive the playback node information from other terminals.

A video providing module 1004 provides the video starting from the first time point to the first terminal device according to the playback instruction.

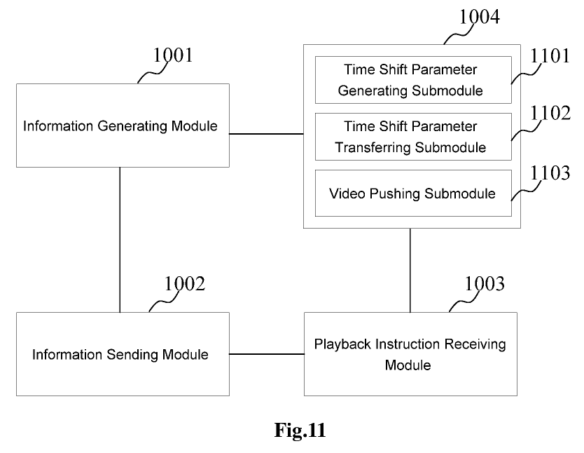

Referring to FIG. 11, in this embodiment or some other embodiments of the present disclosure, the video providing module 1004 may include the following modules.

A time shift parameter generating submodule 1101 calculates a live broadcast time shift parameter according to the first time point.

A time shift parameter transferring submodule 1102 calls a live broadcast stream interface of the video, and transfers the time shift parameter.

A video pushing submodule 1103 pushes a live broadcast stream returned by the live broadcast stream interface to the first terminal device.

In this embodiment or some other embodiments of the present disclosure, the playback node information may further include a picture and\or literal description corresponding to the playback time point.

In this embodiment, a server may generate playback node information for a live broadcast video (for example, it may be automatically generated according to a rule, or it may be generated by a working personnel via an operation) and then push it to each of terminal devices; after a terminal device receives the playback node information and displays it to a user, the user may click a certain playback node information therein so as to send a playback instruction to the server, which makes the server provide a video starting from the playback node, thereby the playback of the live broadcast video may be realized during live broadcast, and the playback timeliness of the live broadcast video may be improved.

The present disclosure may further provide a non-volatile computer readable storage medium stored with computer executable instructions, which are set to perform part or all of the steps in each of implementations of the method for video play applied to a terminal corresponding to the drawings such as FIG. 1 in the above method embodiments.

The present disclosure may further provides another non-volatile computer readable storage medium stored with computer executable instructions, which are set to perform part or all of the steps in each of implementations of the method for video play applied to a server corresponding to the drawings such as FIG. 6 in the above method embodiments.

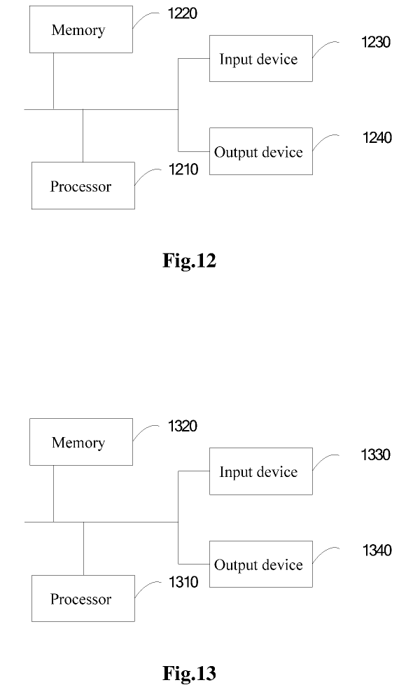

FIG. 12 is a block diagram of a terminal for performing a method for video play according to an exemplary embodiment. The terminal includes one or more processors 1210 and a memory device 1220, and FIG. 12 illustrates one processor 1210 as an example.

The terminal for performing a method for video play may further include an input device 1230 and an output device 1240.

The processor 1210, memory device 1220, input device 1230 and output device 1240 may be connected with each other through bus or other forms of connections. FIG. 12 illustrates bus connection as an example.

As a non-volatile computer readable storage medium, the memory device 1220 may be configured to store non-volatile software program, non-volatile computer executable program and modules, such as program instructions/modules corresponding to the method for video play according to the embodiments of the disclosure (for example, the information receiving module 801, the information displaying module 802, the playback instruction sending module 803 and the playback instruction generating module 804, as illustrated in FIG. 8). By executing the non-volatile software program, instructions and modules stored in the memory device 1220, the processor 1210 may perform various functional applications of the terminal and data processing, that is, the method for video play according to the above mentioned embodiments.

The memory device 1220 may include a program storage area and a data storage area, the program storage area may be stored with the operating system and applications which are needed by at least one functions, and the data storage area may be stored with data which is created according to use of the terminal for video play. Further, the memory device 1220 may include a high-speed random access memory, and may further include non-volatile memory, such as at least one of disk memory device, flash memory device or other types of non-volatile solid state memory device. In some embodiments, optionally, the memory device 1220 may include memory device provided remotely from the processor 1210, and such memory device may be connected with the terminal for video play through network connections. The examples of the network connections may include but not limited to internet, intranet, LAN (Local Area Network), mobile communication network or combinations thereof.

The input device 1230 may receive inputted digital or character information, and generate key signal input related to the user settings and functional control of the terminal for video play. The output device 1240 may include a display device such as a display screen.

The above one or more modules may be stored in the memory device 1220, when these modules are executed by the one or more processor 1210, the method for video play according to any one of the above mentioned embodiments may be performed.

The above product may perform the methods provided in the embodiments of the disclosure, include functional modules corresponding to these methods and advantageous effects. Further technical details which are not described in detail in the present embodiment may refer to the methods provided according to embodiments of the disclosure.

FIG. 13 is a block diagram of a server for performing a method for video play according to an exemplary embodiment. The server includes one or more processors 1310 and a memory device 1320, and FIG. 13 illustrates one processor 1310 as an example.

The server for performing a method for video play may further include an input device 1330 and an output device 1340.

The processor 1310, memory device 1320, input device 1330 and output device 1340 may be connected with each other through bus or other forms of connections. FIG. 4 illustrates bus connection as an example.

As a non-volatile computer readable storage medium, the memory device 1320 may be configured to store non-volatile software program, non-volatile computer executable program and modules, such as program instructions/modules corresponding to the method for video play according to the embodiments of the disclosure (for example, the information generating module 1001, the information sending module 1002, the playback instruction receiving module 1003 and the video providing module 1004, as illustrated in FIG. 10). By executing the non-volatile software program, instructions and modules stored in the memory device 1320, the processor 1310 may perform various functional applications of the server and data processing, that is, the method for video play according to the above mentioned embodiments.

The memory device 1320 may include a program storage area and a data storage area, the program storage area may be stored with the operating system and applications which are needed by at least one functions, and the data storage area may be stored with data which is created according to use of the server for video play. Further, the memory device 1320 may include a high-speed random access memory, and may further include non-volatile memory, such as at least one of disk memory device, flash memory device or other types of non-volatile solid state memory device. In some embodiments, optionally, the memory device 1420 may include memory device provided remotely from the processor 1410, and such memory device may be connected with the server for video play through network connections. The examples of the network connections may include but not limited to internet, intranet, LAN (Local Area Network), mobile communication network or combinations thereof.

The input device 1330 may receive inputted digital or character information, and generate key signal input related to the user settings and functional control of the server for video play. The output device 1340 may include a display device such as a display screen.

The above one or more modules may be stored in the memory device 1320, when these modules are executed by the one or more processor 1310, the method for video play according to any one of the above mentioned embodiments may be performed.

The above product may perform the methods provided in the embodiments of the disclosure, include functional modules corresponding to these methods and advantageous effects. Further technical details which are not described in detail in the present embodiment may refer to the methods provided according to embodiments of the disclosure.

The above mentioned embodiments for the device are merely illustrative, wherein the unit illustrated as a separated component may be or may not be physically separated, the component illustrated as a unit may be or may not be a physical unit, in other words, may be either disposed in a same place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to perform the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for video play, comprising at a terminal:
receiving playback node information sent by a server during a play of a live broadcast video, wherein the playback node information comprises a playback time point of the video;
displaying the playback node information on a live broadcast page of the video;
generating a playback instruction according to the playback time point contained in the playback node information when a user clicks the playback node information; and
sending the playback instruction to the server to make the server provide the video starting from the playback time point.

2. The method according to claim 1, wherein, the playback node information further comprises a picture and\or literal description corresponding to the playback time point.

3. The method according to claim 1, wherein, the playback instruction is a Uniform Resource Locator URL, and a parameter in the URL comprises the playback time point.

4. The method according to claim 3, further comprising:
sharing the URL according to an operation of the user.

5. A method for video play, comprising at a server:
generating playback node information for a current live broadcast video, wherein the playback node information comprises a playback time point of the video;
pushing the playback node information to each of terminal devices that are playing the video;
receiving a playback instruction sent by a first terminal device, wherein the playback instruction comprises a first time point, which is a playback time point of the video by the first terminal device; and
providing the video starting from the first time point to the first terminal device according to the playback instruction.

6. The method according to claim 5, wherein, the providing the video starting from the first time point to the first terminal device according to the playback instruction comprises:
calculating a live broadcast time shift parameter according to the first time point;
calling a live broadcast stream interface of the video, and transferring the time shift parameter; and
pushing a live broadcast stream returned by the live broadcast stream interface to the first terminal device.

7. The method according to claim 5, wherein, the playback node information further comprises a picture and\or literal description corresponding to the time point.

8. The method according to claim 5, wherein the playback instruction is a Uniform Resource Locator URL, and a parameter in the URL comprises the first time point.

9. A terminal, comprising:
at least one processor; and
a memory, communicably connected with the at least one processor and storing instructions executable by the at least one processor,
wherein execution of the instructions by the at least one processor causes the at least one processor to:
receive playback node information sent by a server during a play of a live broadcast video, wherein the playback node information comprises a playback time point of the video;
display the playback node information on a live broadcast page of the video;
generate a playback instruction according to the playback time point contained in the playback node information when a user clicks the playback node information; and
send the playback instruction to the server to make the server provide the video starting from the time point.

10. The terminal according to claim 9, wherein, the playback node information further comprises a picture and\or literal description corresponding to the playback time point.

11. The terminal according to claim 9, wherein, the playback instruction is a Uniform Resource Locator URL, and a parameter in the URL comprises the playback time point.

12. The terminal according to claim 11, wherein, the least one processor is further caused to:
share the URL according to an operation of the user.
